(19) United States
(12) Patent Application Publication
(10) Pub. No.: US 2019/0274279 A1
(43) Pub. Date: Sep. 12, 2019

(54) FEEDING TOOL FOR PETS

(71) Applicant: DoggyMan H. A. Co., Ltd., Osaka (JP)

(72) Inventors: Akio Hayashi, Osaka-shi (JP); Yasushi Nishida, Osaka-shi (JP)

(73) Assignee: DoggyMan H. A. Co., Ltd., Osaka (JP)

(21) Appl. No.: 16/058,242

(22) Filed: Aug. 8, 2018

(30) Foreign Application Priority Data
Mar. 12, 2018 (JP) 2018-044482

(51) Int. Cl. A01K 5/00; A47G 21/00

(52) U.S. Cl. CPC A01K 5/00; A47G 21/00

(57) ABSTRACT

Provided is a feeding tool for pets which can inhibit that scooped food is dropped and hung down to a hand of feeding parson. The feeding tool for pets comprises a grip part, a plate-like member for scooping a paste-like food, which elongates in the direction approximately perpendicular to an axis of the grip part, and a guard part which is disposed between the plate-like member and the grip part. Preferable is that the plate-like member comprises a plurality of plate-like pieces which are disposed at a predetermined distance along the axis of the grip part, or that the guard part extends beyond the plate-like member.

### FIELD OF THE INVENTION

The present invention relates to a feeding tool for pets, and specially relates to a feeding tool for feeding paste-like foods to pets.

### BACKGROUND ART

There has been known a tool for eating a honey by scooping and entangling a honey, for example, at its spiral top, so-called honey dipper (for example, Patent Literature 1).

### PRIOR ARTS

### Patent Literature

Patent Literature 1: Japanese Patent Laid-Open Application 2016-52912, FIG. 1A

### SUMMARY OF THE INVENTION

### Problems to be Solved by the Invention

Generally, the honey dipper is a tool for human. When eating foods by using this tool, the person can operate the tool in order to prevent the scooped foods from dropping and hanging down. However, when feeding foods to a pet by using this tool, it is preferable to set the tool in the stationary state even if being in contact with the pet in order that the pet eats easily. As a result, there is a risk that the scooped food is dropped and hung down to stain a hand of a feeding person.

According to an aspect of the present invention, a feeding tool for pets can be provided, which can inhibit the troubles that the scooped foods are dropped and hung down to the hands of the feeding person.

### Means for Solving the Problems

In order to solve the above problems, the present invention can provide a feeding tool for pets, comprising a grip part, a plate-like member for scooping a paste-like food, which elongates in the direction approximately perpendicular to an axis of the grip part, and a guard part which is disposed between the plate-like member and the grip part.

According to the feeding tool for pets of the present invention having the above construction, it is preferable that the plate-like member comprises a plurality of plate-like pieces which are disposed at a predetermined distance along the axis of the grip part.

According to the feeding tool for pets of the present invention having the above construction, it is preferable that the distance is equal to or more than a thickness of any one of the plate-like pieces.

According to the feeding tool for pets of the present invention having the above construction, it is preferable that the guard part extends beyond the plate-like member.

According to the feeding tool for pets of the present invention having the above construction, it is preferable that the guard part has a rotation-restricting part which prevents the rotation of the feeding tool for pets in the circumferential direction of the guard part when the feeding tool for pets is put on.

### Effects of the Invention

When using the feeding tool for pets of the present invention, it is possible to inhibit the troubles that the scooped foods are dropped and hung down to the hands of the feeding person. Thus, the feeding person can feed more easily not only without staining the hand but also without injuring the pets as mentioned below.

### BRIEF EXPLANATION OF DRAWINGS

FIG. 1 is a perspective view showing a feeding tool 1 for pets according to the one embodiment of the present invention.

FIG. 2 is a front view of the feeding tool 1 for pets shown in FIG. 1.

FIG. 3 is a left side view of the feeding tool 1 for pets shown in FIG. 1.

FIG. 4 is a front view showing a feeding tool 2 for pets according to a modified example of the present embodiment.

FIG. 5 is a left side view of the feeding tool 2 for pets shown in FIG. 4.

### PREFERRED EMBODIMENTS

In the following, feeding tools for pets according to the typical embodiments are explained in detail by referring the drawings. However, the present invention is not limited to these drawings, and can include various modifications within the scope of the present invention.

Since the drawings are to use for explaining the present invention conceptually, for showing the present invention clearly, there is a case where sizes, ratios or number may be shown in the exaggerated or simplified manner, as occasion demand. Here, for explaining easily, the axis X is defined as an axis (in the longitudinal direction) of the grip part, and the plane which is perpendicular to the axis X is defined as the plane YZ. Further, the axis Y is defined in the parallel direction of the rotation-restricting part of the guard part, and the axis Z is defined so as to cross the axis X and the axis Y.

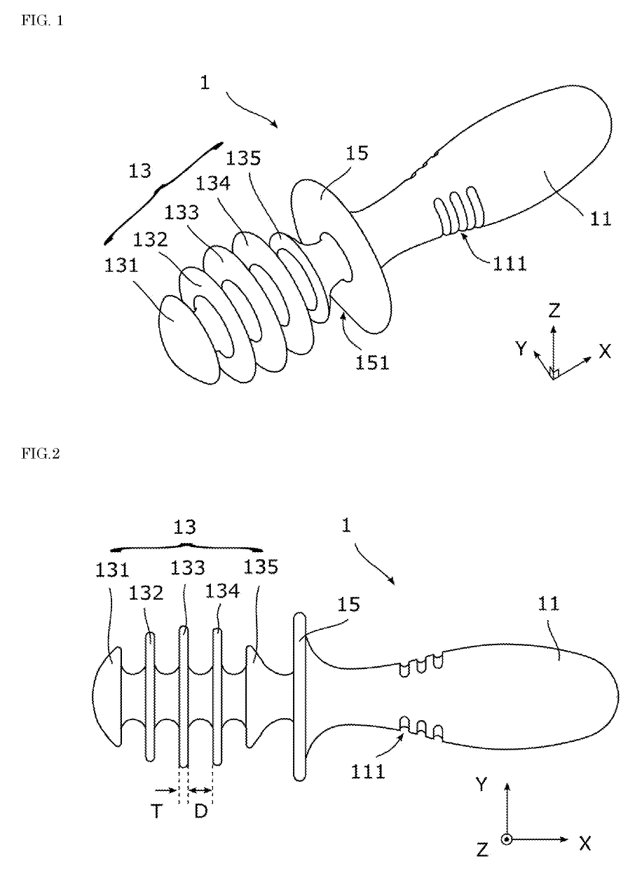

The feeding tool 1 for pets according to the one embodiment of the present invention is explained by referring FIG. 1 to FIG. 3.

The feeding tool 1 for pets can be used for scooping a paste-like food, entangling the paste-like food on the tool due to its viscosity and surface tension to keep the food thereon, and then feeding the food to the pets. In the present embodiment, though targets of the pets are dogs and cats, the invention is not limited thereto and any pets may be included. The size of the feeding tool 1 for pets may be optionally determined according to the kinds of the targeted pets (for example, dogs or cats), and the size (big or small). For example, with respect to a medium-size cat and a small-size dog, the size (total length) of the feeding tool for pets may be around 10 cm.

As shown in FIG. 1, the feeding tool 1 for pets comprises a grip part 11, a plate-like member 13 and a guard part 15. According to the present embodiment, the feeding tool 1 for pets may be, for example, an integrated molded article of a synthetic resin such as a silicone rubber, and also, for example, may be made of other material such as metal or wood, and the parts the feeding tool may be made of different or separated parts or different materials. Anyway, it is important that the parts are constructed so as to be gentle and friendly to the pets without injuring the pets, as shown in the description and drawings.

The grip part 11 is a grip which is held by a feeding person, and extends along with the axis X in the figures. In case that the length of the grip part 11 is short, since the distance between the feeding person and the pet is so close, for example, the pet eats the food while being contact with the arm of the feeding person, and thus physical contact with the pet can be enhanced. The physical contact between the feeding person and the pet during the feeding is important from the viewpoint of mental health of pets. Here, the “short length” means that there is less room in the grip part 11 when the feeding person holds the grip part 11. For example, in case where the total length of the feeding tool for pets is 10 cm, the length of the grip part may be 6 cm in order to close to the pets.

Further, the grip part 11 may have a skid proof part 111 such as grooves which is provided along the circumferential direction of the grip part. Further, the top end (opposite end to the guard part 15) of the grip part 11 may be formed large so that the feeding person can grip easily. Further, a part or all of the grip part 11 may be a synthetic resin such as a rubber like a silicone rubber which has skid proof effect. In case where the skid proof part is provided, even when the preferable physical contact with the pets during the feeding, it is possible to grip the feeding tool 1 firmly.

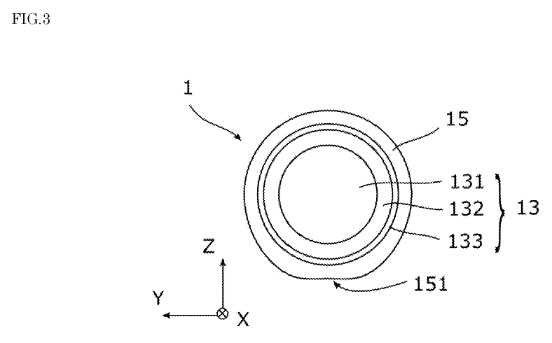

Next, the plate-like member 13 is a member to scoop the paste-like food, and extends in the direction approximately perpendicular to an axis of the grip part 11, namely on the plane approximately parallel to the plane YZ. The surface and the edge of the plate-like member 13 may be subjected to smoothing treatment so that the tongue and mouth of the pet would not be injured. Further, in order that the feeding person can scoop the paste-like food easily and that the pet can eat easily on the plate-like member 13, the plate-like member 13 has a shape of spindle or egg as a whole, when showing the tool in the front view of FIG. 2 (showing along the axis Z).

In the present embodiment, the plate-like member 13 comprises a plurality of plate-like pieces 131 to 135. As shown in FIG. 2, the plate-like pieces 131 to 135 are disposed at a predetermined distance D along the axis of the grip part 11 (direction of the axis X).

The distance D is preferably equal to or more than a thickness T of any one of the plate-like pieces. For example, the plate-like pieces 132 to 134 satisfy the equation: D≥T (wherein the units are the same). When the distance D is equal to or more than the plate thickness T, the tongue of the pet can be inserted easily into the gap, and also the paste-like food can be easily held between the plate-like pieces. In other word, when the gaps between the plate-like pieces 131 to 135 are provided, a larger amount of food to be fed can be scooped and held. Further, the distance D may optionally be selected according to a thickness of tongue of pets.

The plate-like pieces 131 to 135 has approximately disc shape. The plate-like piece 131 positioned at the top of the plate-like member is expanded to the outside direction, and thus the tongue and mouth of the pet are protected from damage. In the present embodiment, though the number of the plate-like pieces is five, the number of the plate-like pieces is not particularly limited.

In the plate-like pieces 131 to 135, the diameter of the plate-like piece 133 at the center position is the maximum, the diameters of the plate-like pieces 132, 134 are medium, and the diameters of the plate-like pieces 131, 135 positioned at the both ends are the minimum. As a result, the plate-like member 13 has a shape of spindle or egg as a whole, and thus, the feeding person can scoop the paste-like food easily and the pet can eat easily that food on the plate-like member 13.

The guard part 15 is so provided as to prevent the food on the plate-like member 13 from hanging down to the hand of the feeding person. As shown in FIG. 1, for example, the guard part 15 is provided between the plate-like member 13 and the grip part 11.

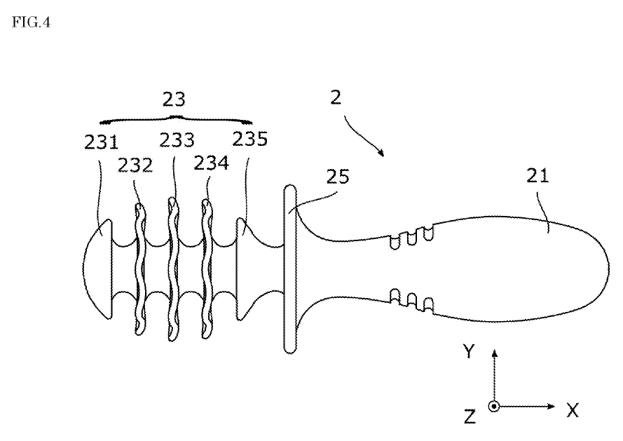

As shown in FIG. 3, the guard part 15 has approximately disc shape, and extends beyond the plate-like member 13. Namely, the guard part 15 has a larger diameter than the plate-like member 13. Thereby, when the feeding tool 1 for pets is put on the table or the like, the plate-like member 13 and the scooped feed are not in contact with the surface of the table, which is hygienic. Further, when the feeding tool 1 for pets is put on, in order that the plate-like member 13 does not touch the surface to be put on, it is preferable that the center of gravity of the feeding tool 1 for pets is positioned at the side of the grip part 11. In other word, the sizes and weights of each part of the feeding tool for pets may be determined so that, even if a large food is scooped and held in the plate-like member 13, the center of gravity is positioned at the side of the grip part 11.

The guard part 15 has a rotation-restricting part 151. The rotation-restricting part 151 prevents the rotation of the feeding tool 1 for pets in the circumferential direction of the guard part 15 when the feeding tool 1 for pets is put on.

In the present embodiment, the rotation-restricting part 151 is formed by making a part of the disc-like member which constitutes the guard part 15 flat, but the present invention is not limited thereto. For example, the rotation-restricting part may be a plurality of projections which project from the circumferential edge of the guard part 15.

When feeding by using the feeding tool 1 for pets, the feeding person holds the grip part 11, and scoops and entangles the food with the plate-like member 13 to adhere or keep on the plate-like member. And then, the adhered food on the plate-like member 13 is fed to the pet.

At that time of feeding, by keeping the position of the plate-like member 13 higher than the grip part 11, even if the food is flowed out from the plate-like member 13, the guard par 15 can prevent the food from dropping or hanging down to the hand of the feeding person by the guard part 15. For example, it is possible to feed to the pet by rotating the feeding tool 1 for pets around the axis of the grip part 11, while effectively preventing a food having a relatively low viscosity (for example, honey) from hanging down from the guard part 15.

### Modified Embodiment

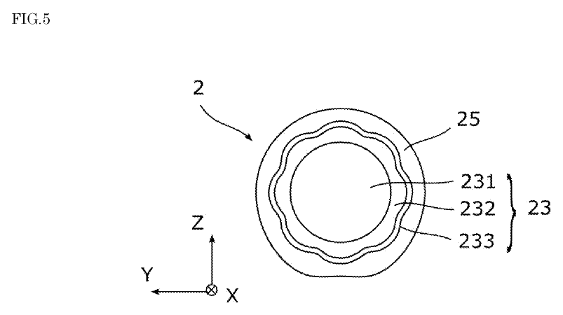

By referring FIG. 4 and FIG. 5, a feeding tool 2 for pets according to a modified example of the present embodiment is explained.

The feeding tool 2 for pets comprises a grip part 21, a plate-like member 23 and a guard part 25 like the feeding tool 1 for pets according to the present embodiment. However, the feeding tool 2 for pets is different from the feeding tool 1 for pets according to the present embodiment in the viewpoint of plate-like pieces 231 to 235, particularly plate-like pieces 232 to 234 which constitute the plate-like member 23.

Specifically, the plate-like pieces 232 to 234 have, as shown in FIG. 4, a shape of wave which waves in the direction of the axis of the grip part 21 (direction of the axis X). Thereby, it is easy to deal with foods having various viscosities.

Further, the circumferential edges of the plate-like pieces 232 to 234 have, as shown in FIG. 5, a shape of wave which waves along the circumferential direction. Thereby, the feeding person can scoop the food more easily.

As explained above, the modified embodiment is constructed so as to improve the operation of the feeding tool for pets, while maintaining the effects which is gentle and friendly to the pets without injuring.

In the above, the typical embodiments of the present invention are explained, but, the present invention is not limited thereto, and can include various modifications within the scope of the present invention.

1. A feeding tool for pets, comprising:
a grip part,
a plate-like member for scooping a paste-like food, which elongates in the direction approximately perpendicular to an axis of the grip part, and
a guard part which is disposed between the plate-like member and the grip part.

2. The feeding tool for pets according to claim 1, wherein
the plate-like member comprises a plurality of plate-like pieces which are disposed at a predetermined distance along the axis of the grip part.

3. The feeding tool for pets according to claim 2, wherein
the distance is equal to or more than a thickness of any one of the plate-like pieces.

4. The feeding tool for pets according to claim 1, wherein
the guard part extends beyond the plate-like member.

5. The feeding tool for pets according to claim 4, wherein
the guard part has a rotation-restricting part which prevents the rotation of the feeding tool for pets in the circumferential direction of the guard part when the feeding tool for pets is put on.
